(19) United States
(12) Patent Application Publication
(10) Pub. No.: US 2013/0185314 A1
(43) Pub. Date: Jul. 18, 2013

(54) GENERATING SCORING FUNCTIONS USING TRANSFER LEARNING

(71) Applicants: Benjamin Rubinstein, Mountain View, CA (US); Olivier Dabrowski, Gilroy, CA (US); Sahand Negahban-Hagh, San Francisco, CA (US); David James Gemmell, Danville, CA (US)

(72) Inventors: Benjamin Rubinstein, Mountain View, CA (US); Olivier Dabrowski, Gilroy, CA (US); Sahand Negahban-Hagh, San Francisco, CA (US); David James Gemmell, Danville, CA (US)

(73) Assignee: Microsoft Corporation, Redmond, WA (US)

(21) Appl. No.: 13/350,821

(22) Filed: Jan. 16, 2012

(51) Int. Cl. G06F 17/30

(52) U.S. Cl. 707/749; 707/748; 707/E17.058

(57) ABSTRACT

Data sources, such as web pages or databases, store or output entities that include data or other information. To compare entities generated by different data sources, and to identify duplicate entities, a scoring function is generated for each pair of data sources that can generate a similarity score that represents the similarity of two entities from the data sources in the pair. To generate the scoring functions, training data is generated for each pair of data sources and reviewed by a judge. The training data is used to generate the scoring functions using machine learning. In order to reduce the amount of training data that is used, transfer learning techniques are applied to use information learned from generating one scoring function for a pair of sources when generating a scoring function for a subsequent pair of sources.

### BACKGROUND

Entity resolution is the problem of performing a noisy database join. Given multiple heterogeneous data sources that store and provide access to entities, entity resolution attempts to determine those entities that are the same, even in the case where the entity representations are noisy or missing attribute values. Entity resolution, also known as entity matching or clustering, is studied in the databases and data mining communities; it is similar to the problem of record linkage studied in statistics, and generalizes the problem of data de-duplication which involves resolving equivalent entities within the one source.

Approaches in these related problems commonly use some kind of scoring function to compare entities from data sources during resolution. In most cases, a scoring function is produced for each pair of data sources. As entity resolution is now being applied to new domains, particularly on the Internet, it is difficult to resolve entities across large numbers of sources. Using a scoring function per pair of data sources may require a large amount of training data. Therefore, performing entity resolution with respect to Internet data sources is difficult.

### SUMMARY

Data sources, such as web pages or databases, store or output entities that include data or other information. Because data sources can have unique data characteristics, in order to compare entities generated by different data sources, and to identify duplicate entities, a scoring function is generated for each pair of data sources that can generate a similarity score that represents the similarity of two entities from the data sources in the pair. To generate the scoring functions, training data is generated for each pair of data sources and manually reviewed by a judge. The training data is used to generate the scoring functions using machine learning. In order to reduce the amount of training data that is used, transfer learning techniques are applied to use information learned from generating one scoring function for a pair of sources when generating a scoring function for a subsequent pair of sources.

In an implementation, identifiers of a plurality of data sources are received at a computing device. Each data source may be associated with a plurality of entities. Training data is received at the computing device. The training data includes pairs of entities, and each pair has an associated similarity score. For each pair of data sources, a scoring function is generated for the pair of data sources using a portion of the training data and information learned from generating a previous scoring function for a previous pair of data sources by the computing device. The scoring function for a pair of data sources may generate a similarity score for pairs of entities that are associated with the pair of data sources. The similarity score may be a binary score (i.e., match or non-match). The plurality of entities associated with each data source of the plurality of data sources is resolved.

In an implementation, training data is received at a computing device. The training data may include a plurality of pairs of entities, each entity may include a plurality of attributes, each pair of entities may have an associated similarity score, and each pair of entities may be associated with a pair of data sources. For each pair of data sources, a scoring function is generated for the pair of data sources using a portion of the training data by the computing device. The scoring function for a pair of data sources may generate a similarity score for entity pairs associated with the pair of data sources. Generating a scoring function for a pair of data sources may include generating a first data structure based on attributes of a first entity of each of the entity pairs that are associated with the pair of data sources, generating a second data structure based on attributes of a second entity of each of the entity pairs that are associated with the pair of data sources, and generating a third data structure based on information learned from generating a previous scoring function. The generated scoring functions are stored by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for performing entity resolution;

FIG. 2 is an illustration of an example entity resolution engine;

FIG. 3 is an operational flow of an implementation of a method of entity resolution;

FIG. 4 is an operational flow of an implementation of a method for generating a scoring function; and

FIG. 5 shows an exemplary computing environment in which example embodiments and aspects may be implemented.

### DETAILED DESCRIPTION

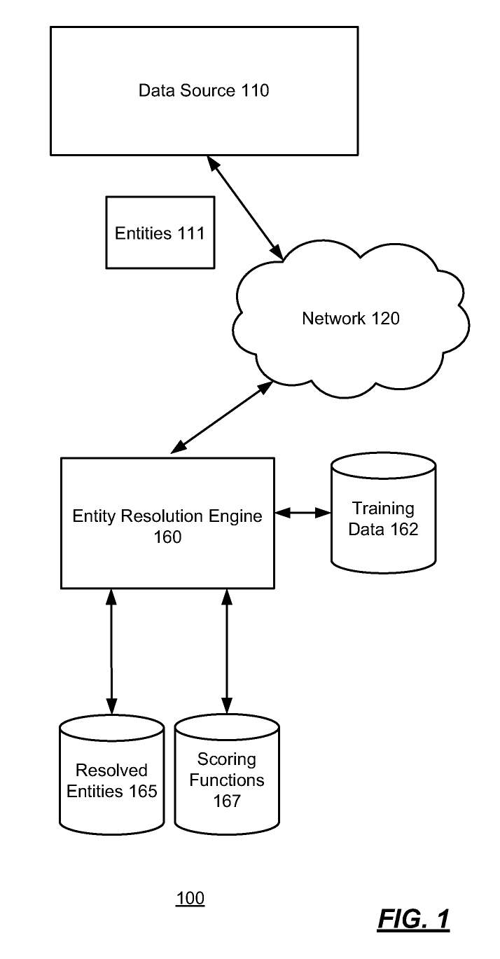

FIG. 1 is an illustration of an example environment 100 for performing entity resolution. A data source 110 may provide one or more entities 111 over a network 120. The data source 110 may be one of a plurality of heterogeneous data sources 110, and each data source 110 may provide entities 111 through the network 120. The data sources 110 may include a variety of heterogeneous data sources including databases, web pages, feeds, social networks, etc. The network 120 may be a variety of network types including the public switched telephone network (PSTN), a cellular telephone network, and a packet switched network (e.g., the Internet).

Each entity 111 may comprise data such as a record from a data source 110, and each entity 111 may include a plurality of attributes. Where the entity is a record, the attributes may correspond to fields of the record. For example, where the data source 110 is a database of films, an entity 111 may correspond to each film and may include attributes such as title, release date, runtime, director, etc. The quality of the entities 111 provided by the data sources 110 may vary, and an entity 111 may include attributes that are noisy, corrupted, or missing.

Some of the entities 111 provided by the data sources 110 may be duplicates, or near duplicates, of one another. However, because of small differences in the attributes or formatting used by the data sources 110, as well as errors or noise in the attributes, identifying such duplicate or near duplicate entities 111 may be difficult. Because of the large number of both data sources 110 and entities 111 on the Internet, an application that uses entities 111, such as a search engine, may want the duplicate entities to be identified and/or removed from a set of entities before they are considered by the search engine.

For example, the following two entities 111 may both represent the film “Citizen Kane”:

Entity 1 <Title> Citizen Kane </Title><Length>119 </Length><Release
Date>1941</Release Date>
Entity 2 <Title> Citizen Kane </Title><Length>90 </Length>.

Both the entity 1 and the entity 2 are duplicates of one another in that they both represent the film “Citizen Kane”. However, the attributes of the entity 2 are different from the attributes of the entity 1 in that the entity 2 lacks the attribute “Release Date”. The entity 2 also includes an error for the length of the film. Thus, while a human observer may immediately recognize that both the entity 1 and the entity 2 describe the same film, and are duplicates, for a computer the task may be more difficult especially when considering the large number of entities 111 and data sources 110 on the Internet.

Accordingly, the environment 100 may include an entity resolution engine 160. The entity resolution engine 160 may receive one or more entities 111 from one or more data sources 110 and may resolve the received entities 111. Resolving the entities 111 may include identifying unique entities 111, or identifying duplicate or near duplicate entities 111. The duplicate or near duplicate entities may then be removed or discarded, and the non-duplicate entities may be stored by the entity resolution engine 160 as the resolved entities 165. Alternatively, the resolved entities 165 may include the duplicate entities along with some indicator that they are duplicates. The resolved entities 165 may then be presented to a search engine, or other application, that uses entities 111.

The entity resolution engine 160 may resolve the entities 111 using one or more scoring functions 167. A scoring function 167 may be associated with a pair of data sources 110, and may be used to generate a similarity score for an entity 111 provided by a first data source 110 in the pair and an entity 111 provided by a second data source 110 in the pair. The similarity score may be a binary score that indicates whether the two entities 111 are duplicates or non-duplicates. The similarity score may further include a confidence value. Other types of similarity scores may be used.

In some implementations, the entity resolution engine 160 may resolve the entities 111 using the scoring functions 167 by selecting or receiving a pair of entities 111, and retrieving the scoring function 167 that corresponds to the pair of data sources 110 that generated the entities of the pair of entities 111. The entity resolution engine 160 may then generate a similarity score for the pair of entities 111 using the retrieved scoring function 167. The entity resolution engine 160 may identify duplicate entities based on the generated similarity scores to generate the resolved entities 165.

The entity resolution engine 160 may generate each of the scoring functions 167 for the pairs of data sources 110 using training data 162. The training data 162 may include pairs of entities 111 that are sampled from the data sources 110. The entities 111 may be sampled using a variety of methods including random sampling. A human reviewer may give each pair of entities 111 a similarity score based on how similar the entities 111 are, or whether the reviewer thinks that the entities 111 are duplicates of each other.

The entity resolution engine 160 may then generate the scoring function 167 for each pair of data sources based on the training data 162 associated with the entities 111 generated by the data sources 110 in the pair. Each scoring function may be generated based on the training data 162 using machine learning, for example. Other methods may also be used.

For “r” number of data sources 110, there may be “r choose 2” unique pairs of data sources 110. Because each data source may have unique data attributes, the entity resolution engine 160 may generate a scoring function 167 for each pair of data sources 110, resulting in r choose 2 scoring functions 167. As may be appreciated, a large amount of training data 162 may be needed to generate the scoring functions 167. Because the training data 162 is manually generated by human reviewers, generating the scoring functions 167 may be expensive and time consuming. In order to reduce the amount of training data 162 used to generate each of the scoring functions 167, the entity resolution engine 160 may use transfer learning (also known as multi-task learning) to generate the scoring functions 167.

Typically, transfer learning problems involve solving a sequence of machine learning (e.g., classification or regression) tasks which are linked in some way. By constraining the solutions of each task to be “close together” during transfer learning, the amount of training data 162 used to generate each scoring function 167 may be decreased. Using transfer learning, generating each scoring function 167 can be considered a task, and information learned by the entity resolution engine 160 during a task of generating one scoring function 167 can be used in a task when generating a different scoring function 167.

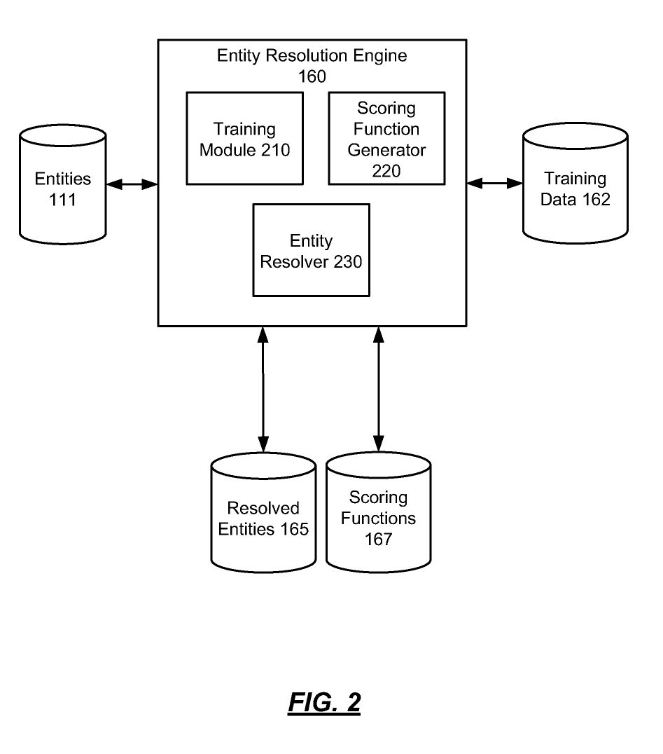

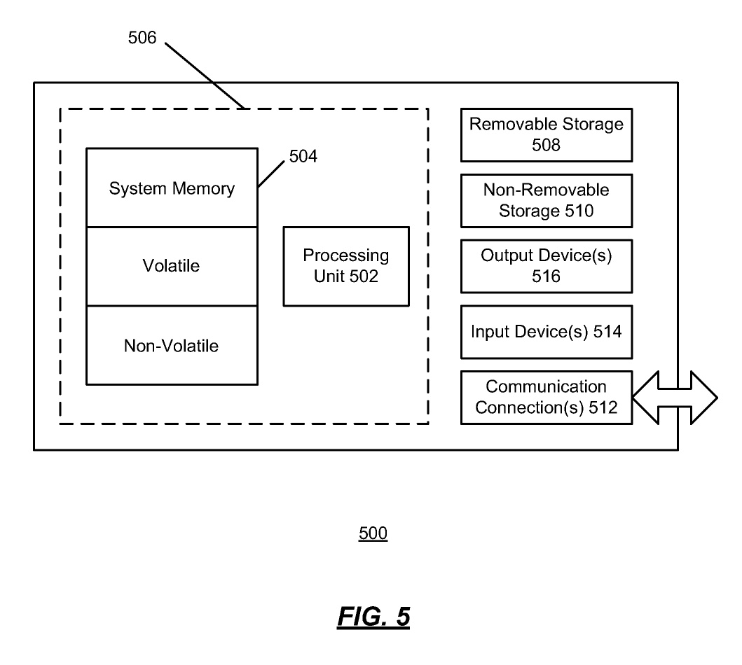

FIG. 2 is an illustration of an example entity resolution engine 160. As shown, the entity resolution engine 160 may include one or more components including, but not limited to, a training module 210, a scoring function generator 220, and an entity resolver 230. While the components are illustrated as part of the entity resolution engine 160, each of the various components may be implemented separately from one another using one or more computing devices such as the computing device 500 illustrated in FIG. 5, for example.

The training module 210 may generate training data 162. In some implementations, the training module 210 may generate the training data 162 by randomly sampling pairs of entities 111 from pairs of data sources 110. Each sampled pair of entities 111 may then be presented to one or more judges who may then generate and assign a similarity score to the sampled pair of entities 111. The score may be a binary score and may indicate if the entities in the pair of entities 111 are duplicate entities or are non-duplicate entities. The judges may manually assign scores. However, automated judges may also be used. The assigned similarity scores may be assigned to the sampled entity pair and stored as the training data 162. Each sampled entity pair and assigned similarity score in the training data 162 may be referred to herein as an example.

In some implementations, rather than randomly sampling both of the entities in a pair for the training data 162, an entity may be selected (either randomly or non-randomly) from a data source 110. The scorer may then be asked to determine another entity from a data source 110 that is a duplicate or a non-duplicate of the selected entity. The selected and determined entities may be stored as an entity pair in the training data 162.

The scoring function generator 220 may use the training data 162 and transfer learning to generate the scoring function 167 for each pair of data sources 110. As described further herein, the scoring function generator 220 may incorporate transfer learning using frequentist statistical methods or Bayesian statistical methods. However, other methods for transfer learning may also be used.

Using frequentist statistical methods, the scoring functions 167 generated by the scoring function generator 220 for each pair of data sources 110 may be linear classifiers. A linear classifier may be represented by a vector normal to a hyperplane. Therefore, the task of generating a scoring function for a pair of data sources may include determining appropriate normal vectors for the pair of data sources. Non-linear classifiers may also be used.

As recognized by the concept of transfer learning, the task of generating a scoring function for a pair of data sources 110 that includes a data source i may share some characteristics with a task of generating a scoring function for any pair of data sources 110 that also includes the data source i. Thus, any information learned by the scoring function generator 220 during a task of generating a scoring function 167 for a pair of data sources 110 that includes a data source i, may be used with other tasks that generate scoring functions for pairs of data sources that also include the data source i using transfer learning. By sharing the information learned in one scoring function generation task with another scoring function generation task, the overall amount of training data 162 used to generate each scoring function 167 may be reduced.

In some implementations, the scoring function generator 220 may generate a linear classifier (i.e., a scoring function 167) for a pair of data sources 110, by generating a weight vector with a weight for each of the attributes of the entities 111 generated by the data sources 110. The generated weight vector may be based on three vectors, for example. The first vector may take into account attributes from entities 111 generated by a first data source of the pair of data sources. The second vector may take into account attributes from entities 111 generated by a second data source of the pair of data sources, or alternatively, differences between the attributes of the entities 111 generated by the first data source and attributes of the entities 111 generated by the second data source.

The third vector may take into account information from attributes of other entities 111 used to generate scoring functions 167 from previous tasks. The third vector therefore may provide the transfer learning with respect to a current scoring function by the scoring function generator 220 and may comprise the information learned by the scoring function generator when generating a previous scoring function 167. In implementations where all of tasks are performed at the same time, the third vector may include information from all of the other tasks.

For example, for any pair of data sources 110i and j, let f_{i,j} denote a weight vector of p real numbers that may be used to generate a similarity score for pairs of entities 111 generated by data sources 110i and j. The weight vector may be represented by equation (1):

f_{i,j}=vₒ+vᵢ+Δ_{i,j} Equation (1)

As illustrated, the weight vector may include three vectors. The vector vᵢ may capture information pertinent to the specific data source i, and may correspond to the first vector described above. The vector Δ_{i,j} may modify the vector vᵢ to also take into account information regarding data source j, and may therefore correspond to the second vector described above. Finally, the vector vₒ may capture attribute learned information across tasks, and may correspond to the third vector described above.

In some implementations, the scoring function generator 220 may use the following general optimization program for transfer learning represented by equation (2):

$${min}_{{{v}_{0} , {v}_{i} , {Δ}_{i , j}}_{s . t .}} \frac{1}{n} {\sum }_{k = 1}^{n} l ( {y}_{k} , 〈 {f}_{i ( k ) , j ( k ) ,} {x}_{k} 〉 ) + {λ}_{0} {Θ}_{0} ( {v}_{0} ) + {λ}_{1} {\sum }_{i = 1}^{r} {Θ}_{1} ( {v}_{i} ) + {λ}_{2} {\sum }_{i , j} {Θ}_{2} ( {Δ}_{i , j} ) \qquad Equation ( 2 )$$

In equation (2), for a data source i, nᵢ may represent a total number of training examples available for the data source i in the training data 162, and n may represent the total number of training examples in the training data 162. The examples available for the data source i may include training data 162 generated for any pair of data sources that include the data source i. The feature vectors for each of the examples in the training data 162 may be represented by x and a vector of the similarity scores assigned to each of the examples in the training data 162 may be represented by y. The vectors x and y may be indexed by k. The functions i(k) and j(k) may map the entities 111 corresponding to a feature of the vector x at the index k to indices of the data sources 110i and j that provided the entities 111. The function I may be a loss function that quantifies how well the similarity score generated by the scoring function of the current task using the feature vector x approximates the similarity score of the vector y. The functions Θ₀, Θ₁, and Θ₂ may be regularization functions.

The parameters λ₀, λ₁, and λ₂ may be parameters that are optimized by the scoring function generator 220. The parameters λ₀, λ₁, and λ₂ may be initially set by a user or administrator and may be adjusted by the scoring function generator 220. Alternatively, the parameters λ₀, λ₁, and λ₂ may be set by the scoring function generator 220 using parameters from a previous scoring function generating task. In some implementations, the parameters may be optimized using cross-validation such as n-fold cross validation or leave-one-out cross validation. The values selected for the parameters may control the amount of transfer that happens between the various tasks.

Where the regularization functions are convex regularization functions, the scoring function generator 220 may iteratively solve equation (2) for the tasks and generate scoring functions 167. Equation (2) may be solved using interior point or conjugate gradient techniques, for example. Other methods may also be used.

In some implementations, equation (2) may be further modified by selecting L₂ loss and L₂ regularization functions for all but the Δ_{i,j} vector. For that vector, the Huber loss function φ(x) may be used. The result is equation (3):

$${min}_{{{v}_{0} , {v}_{i} , {Δ}_{i , j}}_{s . t .}} \frac{1}{n} {\sum }_{k = 1}^{n} {( {y}_{k} - 〈 {f}_{i ( k ) , j ( k ) ,} {x}_{k} 〉 )}^{2} + {λ}_{0} {‖ {v}_{0} ‖}_{2}^{2} + {λ}_{1} {\sum }_{i = 1}^{r} {‖ {v}_{i} ‖}_{2}^{2} + {λ}_{2} {\sum }_{i , j} φ ( {Δ}_{i , j} ) \qquad Equation ( 3 )$$

Multiplying the objective of equation (3) by ½ results in the equation (4):

$${min}_{{{v}_{0} , {v}_{i} , {Δ}_{i , j}}_{s . t .}} \frac{1}{2 n} {\sum }_{k = 1}^{n} {( {y}_{k} - 〈 {f}_{i ( k ) , j ( k ) ,} {x}_{k} 〉 )}^{2} + \frac{{λ}_{0}}{2} {‖ {v}_{0} ‖}_{2}^{2} + \frac{{λ}_{1}}{2} {\sum }_{i = 1}^{r} {‖ {v}_{i} ‖}_{2}^{2} + \frac{{λ}_{2}}{2} {\sum }_{i , j} φ ( {Δ}_{i , j} ) \qquad Equation ( 4 )$$

In some implementations, the scoring function generator 220 may then generate the scoring functions 167 by solving equation (4) using standard block-coordinate procedures. The updates may be based on the equations (5) and (6), where t is a current scoring function 167 generating task and H is a Hessian Matrix:

$$\begin{matrix}{v}_{0}^{t + 1} = ( 1 - μ ) {v}_{0}^{t} - μ {H ( {v}_{0} )}^{- 1} [ \frac{1}{n} {\sum }_{k = 1}^{n} {x}_{k} ( 〈 {x}_{k} , {v}_{i ( k )} + {Δ}_{e ( k )} 〉 - {y}_{k} ) ] & Equation ( 5 ) \\ {v}_{i}^{t + 1} = ( 1 - μ ) {v}_{i}^{t} - μ {H ( {v}_{i} )}^{- 1} [ \frac{1}{n} {\sum }_{k ∈ \{ j \vert i ( j ) = i \}} {x}_{k} ( 〈 {x}_{k} , {v}_{i ( k )} + {Δ}_{e ( k )} 〉 - {y}_{k} ) ] & Equation ( 6 )\end{matrix}$$

As noted above, in some implementations, the scoring function generator 220 may also generate the scoring functions 167 using Bayesian statistical methods. In Bayesian statistics, probabilistic graphical models may be used to represent the scoring functions 167. The examples from the training data 162 in the form of attribute vectors and associated similarity scores may be represented by the scoring function generator 220 as nodes in a graph. Directed edges between the nodes may be used to represent a probabilistic dependence between the nodes. The scoring function generator 220 may generate a graph for the series of tasks with a sub-graph for each task based on the examples in the training data 162.

Transfer learning in the above described Bayesian graphical models may be represented by what are called hyper-parameters. A hyper-parameter may be a node that connects with nodes associated with different scoring function generation tasks, and may represent similarities between the nodes. The scoring function generator 220 may create the hyper-parameters when generating the scoring functions 167 for a task, and may use the information provided by previously generated hyper-parameters when generating the scoring functions 167 for subsequent tasks.

The entity resolver 230 may resolve the entities 111 using the scoring functions 167 generated by the scoring function generator. The resolved entities 165 may be stored or provided to an application such as a search engine, for example.

In some implementations, the entity resolver 230 may resolve the entities 111 by using the generated scoring functions 167 to identify pair of entities 111 from the data sources 110 that are duplicates. The entity resolver 230 may then discard one or more of the duplicate entities 111.

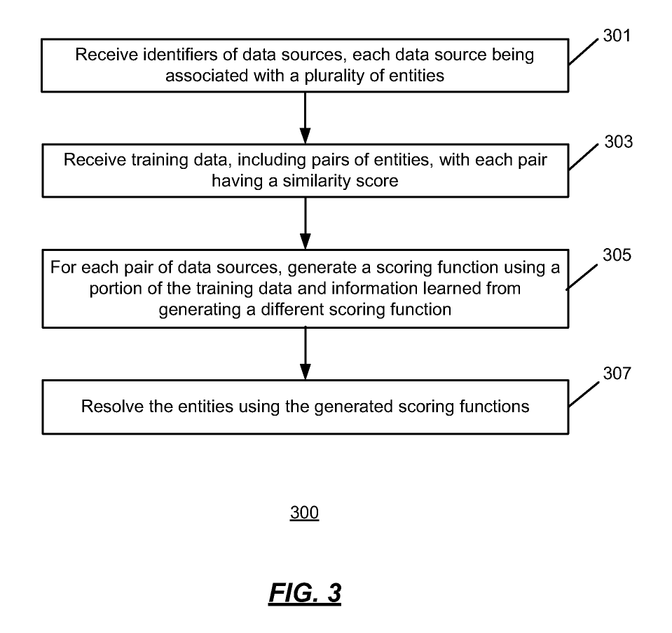

FIG. 3 is an operational flow of an implementation of a method 300 for performing entity resolution. The method 300 may be implemented by the entity resolution engine 160, for example.

Identifiers of a plurality of data sources are received at 301. The identifiers of a plurality of data sources 110 may be received by the entity resolution engine 160. The data sources 110 may be data sources that a search engine, or other application, would want the entity resolution engine 160 to resolve. The data sources 110 may include web pages, feeds, databases, and social networks, for example. Each of the data sources 110 may be associated with a plurality of entities 111. Each entity 111 may be a collection of data, such as a record, for example.

Training data is received at 303. The training data 162 may be received by a scoring function generator 220 of the entity resolution engine 160. The training data 162 may include pairs of entities 111 and a similarity score that was generated based on the similarity of the entities 111. In an implementation, the similarity score may have been manually generated by a human judge or scorer. The training data 162 may have been generated by the training module 210 from entities 111 sampled from the data sources 110.

For each pair of data sources, a scoring function is generated using a portion of the training data and information learned from generating a different scoring function for a different pair of data sources at 305. The scoring function 167 may be generated by the scoring function generator 220 of the entity resolution engine 160. In some implementations, the information learned from generating a different scoring function may be the transfer learning. In some implementations, the scoring function 167 may be generated using frequentist or Bayesian statistical techniques.

The plurality of entities is resolved using the generated scoring functions at 307. The plurality of entities is resolved by the entity resolver 230. In some implementations, resolving the entities 111 may include using the generated scoring functions to identify pairs of entities 111 from the data sources 110 that are duplicates. The duplicate entities 111 may then be optionally removed or otherwise identified, and the entities may be stored as the resolved entities 165.

In other implementations, resolving the entities may include receiving pairs of entities 111 from an application, retrieving a scoring function 167 generated for the pair of data sources 110 that are associated with the received pair of entities 111, and generating the similarity score for the pair of entities 111. The generated similarity score may then be provided to the application.

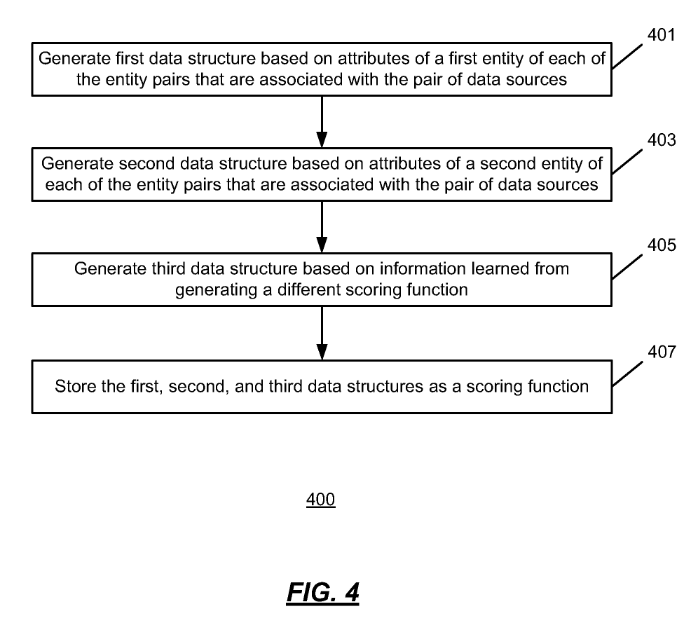

FIG. 4 is an operational flow of an implementation of a method 400 for generating a scoring function. The method 400 may be implemented by the scoring function generator 220. The scoring function 167 may be generated by the scoring function generator 220 for a pair of data sources 110 based on training data 162 generated by the training module 210. The training data 162 may include pairs of entities associated with the data sources 110 along with a generated similarity score for each pair of entities.

A first data structure is generated at 401. In an implementation, the first data structure may be a vector, and may be generated by the scoring function generator 220 based on attributes of a first entity of each of the entity pairs that are associated with the pair of data sources 110 for which the scoring function 167 is being generated. The first data structure may correspond to the vector vᵢ of equation (1). The first data structure may be generated using machine learning techniques based on the attributes of the first entities in each of the entity pairs and the generated similarity score for each of the entity pairs.

A second data structure is generated at 403. In an implementation, the second data structure may be a vector, and may be generated by the scoring function generator 220 based on attributes of a second entity of each of the entity pairs that are associated with the pair of data sources 110. The second data structure may correspond to the vector Δ_{i,j} of equation (1).

A third data structure is generated at 405. In an implementation, the third data structure may be a vector, and may be generated by the scoring function generator 220 based on information learned from generating a different scoring function. The information may be transfer learning. The information may comprise patterns found in the training data 162. Alternatively or additionally, the third data structure may include information that is common to all of the scoring functions, information that is common to scoring functions for data source 110 pairs that have an entity in common, or information that is common to the data sources 110 in the pair. The third data structure may correspond to the vector v₀ of equation (1).

The first, second, and third data structures are stored at 407. The first, second, and third data structures may be stored by the scoring function generator 220 as a scoring function 167 for the pair of data sources 110.

FIG. 5 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 5, an exemplary system for implementing aspects described herein includes a computing device, such as computing device 500. In its most basic configuration, computing device 500 typically includes at least one processing unit 502 and memory 504. Depending on the exact configuration and type of computing device, memory 504 may be volatile (such as random access memory (RAM)), non-volatile (such as read-only memory (ROM), flash memory, etc.), or some combination of the two. This most basic configuration is illustrated in FIG. 5 by dashed line 506.

Computing device 500 may have additional features/functionality. For example, computing device 500 may include additional storage (removable and/or non-removable) including, but not limited to, magnetic or optical disks or tape. Such additional storage is illustrated in FIG. 5 by removable storage 508 and non-removable storage 510.

Computing device 500 typically includes a variety of computer readable media. Computer readable media can be any available media that can be accessed by computing device 500 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 504, removable storage 508, and non-removable storage 510 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 500.

Computing device 500 may contain communication connection(s) 512 that allow the device to communicate with other devices. Computing device 500 may also have input device(s) 514 such as a keyboard, mouse, pen, voice input device, touch input device, etc. Output device(s) 516 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving identifiers of a pair of data sources at a computing device, wherein the pair of data sources is associated with a plurality of entities;
generating a scoring function for the pair of data sources using transfer learning, the transfer learning comprising generating one of a linear or a non-linear classifier for a different pair of data sources by the computing device, wherein the one of a linear or a non-linear classifier is determined by generating a similarity score for at least a first pair of entities that are associated with the different pair of data sources; and
using the scoring function to generate in the computing device, a similarity score for at least a second pair of entities among the plurality of entities.

2. (canceled)

3. The method of claim 1, wherein each of the pair data sources and the different pair of data sources is one of a database, a web page, a feed, or a social network.

4. The method of claim 1, further comprising:
receiving training data at the computing device, wherein the training data comprises pairs of entities and each pair of the pairs of entities has an associated similarity score, and further wherein at least a portion of the training data is manually generated.

5. The method of claim 1, wherein the similarity score comprises a binary value.

6. The method of claim 5, wherein the similarity score further comprises a confidence value.

7. The method of claim 1, wherein the pair of data sources is a heterogeneous pair of data sources.

8. (canceled)

9. The method of claim 1, wherein generating the scoring function using transfer learning comprises using at least one of frequentist statistics or Bayesian statistics.

10. A method comprising:
receiving training data at a computing device, wherein the training data comprises a plurality of pairs of entities, each entity comprises a plurality of attributes, each pair of entities has an associated similarity score, and each pair of entities is associated with a pair of data sources;
for each pair of data sources, generating a scoring function for the pair of data sources using a portion of the training data by the computing device, wherein the scoring function for a pair of data sources generates a similarity score for entity pairs associated with the pair of data sources, and further wherein generating a scoring function for a pair of data sources comprises:
generating a first data structure based on attributes of a first entity of each of the entity pairs that are associated with the pair of data sources;
generating a second data structure based on attributes of a second entity of each of the entity pairs that are associated with the pair of data sources; and
generating a third data structure based on information learned from generating other scoring functions; and
storing the generated scoring functions by the computing device.

11. The method of claim 10, further comprising:
receiving a pair of entities associated with a pair of data sources;
retrieving the generated scoring function corresponding to the pair of data sources;
generating a similarity score for the received pair of entities using the generated scoring function; and
providing the generated similarity score.

12. The method of claim 10, wherein the generated first, second, and third data structures are vectors.

13. The method of claim 10, wherein each of the plurality of data sources comprises one of a database, a web page, a feed, or a social network.

14. The method of claim 10, wherein the training data is manually generated.

15. The method of claim 10, where in the plurality of entities are records and the plurality of data sources are databases.

16. A system comprising:
at least one computing device comprising:
a training module adapted to:
sample a plurality of pairs of entities from a plurality of data sources; and
generate a similarity score for each sampled pair of entities from the plurality of entities; and
a scoring function generator adapted to:
for each pair of data sources, generate a scoring function based on the similarity scores generated for each sampled pair of entities and information learned from generating a one of a linear or a non-linear classifier for a different pair of data sources; and
store the generated scoring function.

17. The system of claim 16, further comprising an entity resolver adapted to resolve the plurality of entities associated with each data source using the generated scoring function.

18. The system of claim 16, further comprising an entity resolver adapted to:
receive a pair of entities associated with a pair of data sources from the plurality of data sources;
retrieve the generated scoring function corresponding to the pair of data sources;
generate a similarity score for the received pair of entities using the generated scoring function; and
provide the generated similarity score.

19. The system of claim 16, wherein the plurality of entities are records and the plurality of data sources are databases.

20. The system of claim 16, wherein the scoring function generator is adapted to generate the scoring function using transfer learning.

21. The method of claim 1, wherein the pair of data sources is part of “r” number of data sources and the scoring function is part of “r choose 2” scoring functions that are derived from the “r” number of data sources, at least in part by using transfer learning.
